(19) United States
(12) Patent Application Publication
(10) Pub. No.: US 2016/0092938 A1
(43) Pub. Date: Mar. 31, 2016

(54) REQUESTING ADVERTISEMENTS INSERTED INTO A FEED OF CONTENT ITEMS BASED ON ADVERTISING POLICIES ENFORCED BY AN ONLINE SYSTEM

(71) Applicant: Facebook, Inc., Menlo Park, CA (US)

(72) Inventor: Yi Tang, Mountain View, CA (US)

(21) Appl. No.: 14/497,853

(22) Filed: Sep. 26, 2014

(51) Int. Cl. G06Q 30/02

(52) U.S. Cl. CPC G06Q 30/0277

(57) ABSTRACT

An online system presents advertisements and content items to its users in a feed of content items (e.g., a newsfeed). The online system enforces one or more advertisement policies regulating insertion of advertisements into the feed and determines a predicted likelihood that enforcing the advertising policies will prevent insertion of additional advertisements into the feed of content items when a request to present content via the feed is received from a user of the online system. Advertising policies describe conditions preventing insertion of additional advertisements into the feed (e.g., positions in the feed that may not be occupied by advertisements, a minimum distance separating advertisements in the feed, etc.). Based on the predicted likelihood, the online system determines whether to request one or more additional advertisements for insertion into the feed from an advertisement service.

### BACKGROUND

This disclosure relates generally to presentation of content by an online system, and more specifically to requesting content items subject to one or more policies regulating locations of presented content items relative to each other.

An online system, such as a social networking system, allows its users to connect to and communicate with other users. Users may create profiles on an online system that are tied to their identities and include information about the users, such as interests and demographic information. The users may be individuals or entities such as corporations or charities. Establishing connections with other users via an online system allows a user to more easily share content with the other users. When the online system receives an interaction with content from a user, the online system stores information describing the interaction and may generate a content item describing the interaction that is presented to other online system users connected to the user in a feed of content items. Presenting users with content items describing interactions may increase user interaction with the online system.

Additionally, entities (e.g., a business) may present content items to online system users to gain public attention for products or services or to persuade online system users to take an action regarding products or services provided by the entity. Many online systems may receive compensation from an entity for presenting certain types of content items provided by the entity to online system users. Frequently, online systems charge an entity for each presentation of certain types of content to an online system user (e.g., each “impression” of the content) or for each interaction with the certain types of content by online system users.

Many conventional online systems obtain certain types of content for presentation to users from the entity or from a third party service. For example, when an online system receives a request from a user of the online system to refresh a feed that includes content items presented to the user, the online system communicates a request for one or more content items to an entity or to a third party service, which provides certain types of content items for inclusion in the feed presented to the user. However, to present the user with content with which the user is most likely to interact and to enhance user interaction with the online system, many online system enforce one or more policies regulating positions of certain types of content items in a feed of content items. For example, a policy prevents certain types of content items from being presented in specific locations in a feed of content item (e.g., a most prominent location, an initial location) so the feed presents other types of content items, which the online system determines are more likely to be of interest to users, in the specific locations of the feed of content items. Enforcing one or more policies regulating positions of content items may prevent presentation of certain types of content items requested from an entity or from a third party service, so communicating a request to an advertisement service for the certain types of content items may be a waste of computing resources if application of the one or more policies after receiving the certain types of content items prevents insertion of the certain types of content item into a feed of content items presented by the online system.

### SUMMARY

An online system presents advertisements and content items to its users via a feed of content items (e.g., a newsfeed). To enhance user interaction, the online system enforces one or more advertising policies that regulate insertion and positioning of advertisements within the feed of content items. An advertising policy specifies one or more conditions that prevent insertion of one or more advertisements into a feed of content items. Characteristics of the feed of the content items are evaluated by the online system to determine if one or more conditions preventing insertion of an advertisement are satisfied. For example, advertising policies regulate positions in a feed of content items in which an advertisement may be presented, specify a minimum distance between separate advertisements in a feed of content items (e.g., a threshold number of pixels between advertisements presented by the feed), specify a maximum ratio of advertisements to content items in a feed, or specify other conditions regulating inclusion of advertisements in a feed.

When retrieving content items to evaluate for inclusion in a feed of content items, the online system requests advertisements from a third-party system, such as an advertisement service, for inclusion in the feed. Before requesting advertisements from the third party system, the online system determines a predicted likelihood that advertising policies enforced by the online system will prevent insertion of additional advertisements into a feed of content items. For example, after receiving a request to present a feed of content items to a user of the online system (e.g., the user refreshes a page presenting a newsfeed), the online system determines the predicted likelihood that one or more advertisement policies enforced by the online system will prevent inclusion of additional advertisements in the feed. Based on the predicted likelihood that enforcement of one or more advertisement policies will prevent inclusion of advertisements in the feed, the online system determines whether to request one or more advertisements for inclusion in the feed. For example, the online system requests one or more advertisements from a third party system if the predicted likelihood is less than a threshold value but does not request additional advertisements form the third party system if the predicted likelihood is greater than the threshold value. This reduces the likelihood that the online system wastes computing resources by sending requests to the advertisement service for advertisements that are unlikely to be presented to a user via the feed based on enforcement of advertisement policies by the online system. However, in some embodiments, the online system communicates a request to the third party system regardless of the predicted likelihood, but includes in the request an indication for the third party to ignore the request if the predicted likelihood of enforcing one or more advertising policies has at least a threshold likelihood. For example, a request for one or more advertisements sent to the third party system includes an embedded code that, when identified by the third party system, causes the third party system to ignore the request.

In one embodiment, the online system uses a trained model (e.g., a machine learned model) to predict the likelihood that advertising policies will prevent insertion of one or more advertisements into a feed of content items. The trained model may predict the likelihood based on characteristics associated with a user requesting the feed and characteristics of the feed itself. For example, a ratio of advertisements to other types of content items in a feed presented to the user and ratios of advertisements to other types of content items in feeds previously presented to the user are determined, and the machine learned model determines a low likelihood of enforcement of one or more advertisement policies preventing inclusion of one or more advertisements in the feed if ratios of advertisements to other types of content items in feeds presented to the user when the user requested additional content when presented with a feed having a matching or similar ratio of advertisements to other types of content items included at least a threshold number or percentage of advertisements.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIG. 3 is an interaction diagram of a method for determining whether to request one or more advertisements from an advertisement service, in accordance with an embodiment.

FIG. 4 is an example of determining whether to insert an additional advertisement into a feed of content items, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

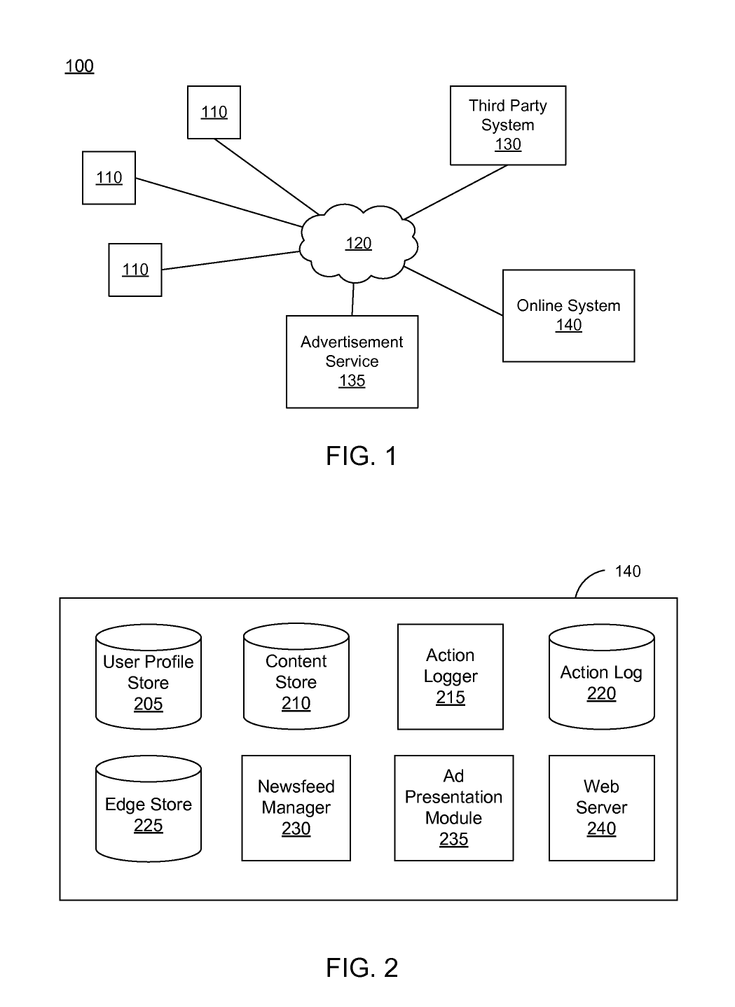

FIG. 1 is a block diagram of a system environment 100 for an online system 140, such as a social networking system. The system environment 100 shown by FIG. 1 comprises one or more client devices 110, a network 120, one or more third-party systems 130, one or more advertisement services 135, and the online system 140. In alternative configurations, different and/or additional components may be included in the system environment 100.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device 110. In other embodiments, a third party system 130 provides content or other information for presentation via a client device 110. A third party system 130 may also communicate information to the online system 140, such as advertisements, content, or information about an application provided by the third party system 130.

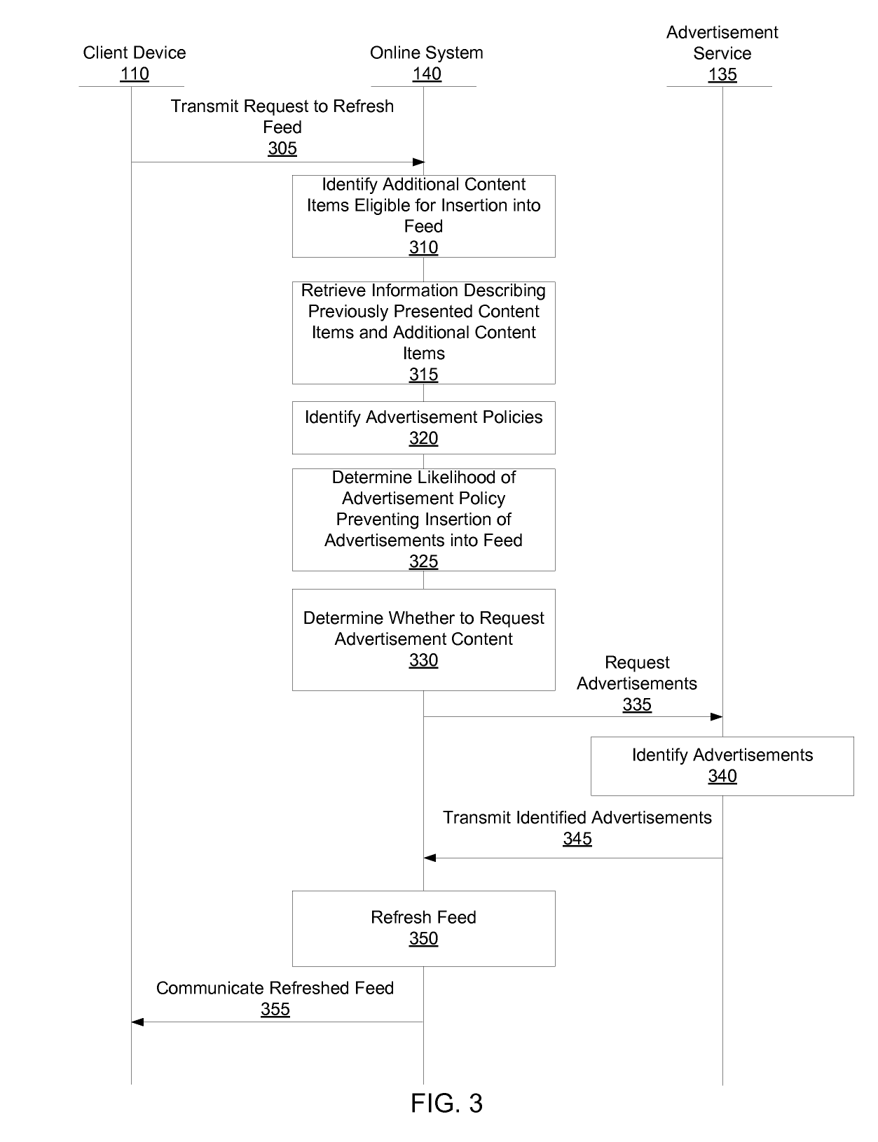

Additionally, one or more advertisement services 135 are coupled to the network 120 to communicate with the online system 140 or with one or more third party systems 130. An advertisement service 135 identifies advertisements stored by the advertisement service 135 or by a third party system 130 and provides the identified advertisements to the online system 140 for presentation to users. For example, an advertisement service 135 receives a request for advertisements from the online system 140 and communicates advertisements to the online system 140 based on the request. Information describing one or more advertisements and/or information describing the user to whom advertisements are to be presented may be included in the request. Example information describing one or more advertisements included in the request include: a number of advertisements, a size of advertisements (e.g., a number of pixels specifying a height or a width of various advertisements), a type associated with advertisements (e.g., banner advertisement), a genre associated with advertisements (e.g., subject matter included in the advertisements), types of content included in the advertisements (e.g., video data, image data, audio data), bid amounts associated with advertisements, an operating system used to present the advertisements, and a type of client device 110 used to present the advertisements. Information describing a user to whom advertisements are to be presented include: targeting criteria associated with the user, a description of a client device 110 associated with the user, and an indication of an operating system associated with the user. Communication of advertisement requests from the online system 140 to an advertisement service 135 is further described below in conjunction with FIG. 3.

FIG. 2 is a block diagram of an architecture of the online system 140. An example of an online system 140 is a social networking system. The online system 140 shown in FIG. 2 includes a user profile store 205, a content store 210, an action logger 215, an action log 220, an edge store 225, a newsfeed manager 230, an advertisement (“ad”) presentation module 235, and a web server 240. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding online system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the online system users displayed in an image. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other online system users. The entity may post information about itself, about its products or provide other information to users of the online system using a brand page associated with the entity's user profile. Other users of the online system may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a page (e.g., brand page), or any other type of content. Online system users may create objects stored by the content store 210, such as status updates, photos tagged by users to be associated with other objects in the online system 140, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with those users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: commenting on posts, sharing links, checking-in to physical locations via a mobile device, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce websites, such as in the preceding example, may communicate information about a user's actions outside of the online system 140 to the online system 140 for association with the user. Hence, the action log 220 may record information about actions users perform on a third party system 130, including webpage viewing histories, advertisements that were engaged, purchases made, and other patterns from shopping and buying.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

In one embodiment, an edge may include various features each representing characteristics of interactions between users, interactions between users and objects, or interactions between objects. For example, features included in an edge describe a rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the online system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate a user's interest in an object, a topic, or another user in the online system 140 based on actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

In one embodiment, the online system 140 identifies stories likely to be of interest to a user through a “newsfeed” presented to the user. A story presented to a user describes an action taken by an additional user connected to the user and identifies the additional user. In some embodiments, a story describing an action performed by a user may be accessible to users not connected to the user that performed the action. The newsfeed manager 230 may generate stories for presentation to a user based on information in the action log 220 and in the edge store 225 or may select candidate stories included in content store 210. One or more of the candidate stories are selected and presented to a user by the newsfeed manager 230.

For example, the newsfeed manager 230 receives a request to present one or more stories to an online system user. The newsfeed manager 230 accesses one or more of the user profile store 205, the content store 210, the action log 220, and the edge store 225 to retrieve information about the identified user. For example, stories or other data associated with users connected to the identified user are retrieved. The retrieved stories, or other retrieved data, are analyzed by the newsfeed manager 230 to identify content likely to be relevant to the identified user. For example, stories associated with users not connected to the identified user or stories associated with users for which the identified user has less than a threshold affinity are discarded as candidate stories. Based on various criteria, the newsfeed manager 230 selects one or more of the candidate stories for presentation to the identified user.

In various embodiments, the newsfeed manager 230 presents stories to a user through a newsfeed including a plurality of stories selected for presentation to the user. The newsfeed may include a limited number of stories or may include a complete set of candidate stories. The number of stories included in a newsfeed may be determined in part by a user preference included in user profile store 205. The newsfeed manager 230 may also determine the order in which selected stories are presented via the newsfeed. For example, the newsfeed manager 230 determines that a user has a highest affinity for a specific user and increases the number of stories in the newsfeed associated with the specific user or modifies the positions in the newsfeed where stories associated with the specific user are presented.

The newsfeed manager 230 may also account for actions by a user indicating a preference for types of stories and selects stories having the same, or similar, types for inclusion in the newsfeed. Additionally, the newsfeed manager 230 may analyze stories received by the online system 140 from various users to obtain information about user preferences or actions from the analyzed stories. This information may be used to refine subsequent selection of stories for newsfeeds presented to various users.

The ad presentation module 235 determines a predicted likelihood that advertising policies enforced by the online system 140 will prevent insertion of additional advertisements into a feed of content items for presentation to a user. Characteristics of the user, characteristics of the feed of content items, and conditions regulating presentation of advertisements are used by the ad presentation module 235 to determine the predicted likelihood. An advertising policy specifies one or more conditions that prevent insertion of one or more advertisements into a feed of content items. Example advertising policies include: advertisement policies identifying positions in a feed of content items in which advertisements may not be presented (e.g., preventing advertisements from occupying the first position in a newsfeed), advertisement policies identifying position in a feed of content items in which advertisements are capable of being presented, an advertising policy specifying a ratio of advertisements and other types of content items presented by the feed of content items, and advertisement policies specifying a minimum distance between advertisements presented by a feed of content items (e.g., a minimum number of pixels between advertisements presented in the feed of content items). For example, an advertising policy prevents an advertisement from being presented within five positions of a position in a feed of content items in which another advertisement is presented. As an additional example, an advertising policy specifies a minimum of 480 pixels between advertisements presented in a feed of content items.

The predicted likelihood may be expressed as a percentage. For example, based on an advertising policy specifies a maximum ratio of advertisements to content items, the ad presentation module 235 determines there is a 5% likelihood that enforcing the advertising policy will prevent insertion of one or more advertisements inserted into a newsfeed that includes greater than a threshold number of content items. Alternatively, the predicted likelihood may be expressed as a score, which may be based on a percentage. For example, if enforcement of an advertising policy prevents advertisements from occupying a specific position in a content feed, the ad presentation module 235 determines there is a 95% likelihood that, when enforced, the advertising policy will prevent inclusion of one or more advertisements in a vertically-scrollable newsfeed in which the specific position the newsfeed is available for presentation of content, and specifies the predicted likelihood as a score of 9.5 out of a possible score of 10.

In one embodiment, a trained model (e.g., a machine learned model) determines the predicted likelihood that enforcing one or more advertisement policies will prevent insertion of one or more advertisements into a feed of content items presented to a user. The trained model may predict the likelihood based on characteristics associated with a user requesting the feed, characteristics of the feed itself, and conditions specified by the one or more advertisement policies. Example characteristics associated with the user include: a time associated with the user, a location associated with the user, an operating system associated with the user, prior requests from the user to retrieve content for the feed, content items eligible for presentation to the user, and content items previously presented to the user via the feed. Characteristics associated with the feed include: a ratio of advertisements to other content items included in the feed, advertisements previously included in the feed, a number of content items previously included in the feed, and positions in the feed in which additional content items are eligible to be presented. Various characteristics of the user or of the feed are compared to conditions specified by one or more advertising policies, and one or more machine learned models generate values based on conditions specified by the one or more advertising policies, with the values used to determine the likelihood that enforcing one or more of the advertising policies prevents inclusion of advertisements in the feed. For example, a machine learned model predicts a high likelihood that enforcing one or more advertising policies will prevent insertion of an additional advertisement into a newsfeed presented to an online system user if less than a threshold number of advertisements were included in the newsfeed in response to prior requests for content to include in the newsfeed. Multiple models may be used to determine the likelihood that enforcing one or more advertising policies will prevent inclusion of one or more advertisements in a feed, different models may be used to evaluate different advertising policies.

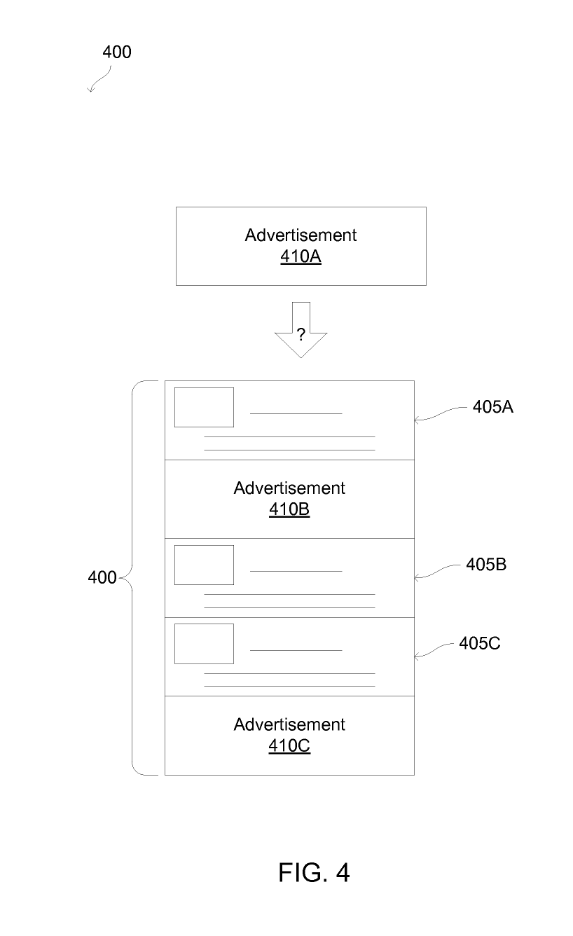

Based on the determined likelihood that enforcing one or more advertising policies will prevent inclusion of one or more advertisements in a feed of content items, the ad presentation module 235 determines whether to request one or more advertisements from an advertisement service 135. If the determined likelihood that enforcing one or more advertising policies will prevent inclusion of one or more advertisements in a feed of content items is greater than a threshold value, the ad presentation module 235 does not request one or more advertisements from the advertisement service 135, as it is sufficiently unlikely that the advertisements will be presented by the feed that requesting the advertisements consumes computing resources without providing a benefit to the online system. However, if that enforcing one or more advertising policies will prevent inclusion of one or more advertisements in a feed of content items is less than the threshold value, the ad presentation module 235 communicates a request for one or more advertisements to the advertisement service 135. Determination of a predicted likelihood that enforcing advertising policies will prevent insertion of advertisements into a feed of content items and whether to request advertisements from an advertisement service 135 based on the predicted likelihood that enforcing advertising policies will prevent insertion of advertisements into the feed is further described below in conjunction with FIGS. 3 and 4.

The web server 240 links the online system 140 via the network 120 to the one or more client devices 110, as well as to the one or more third party systems 130. The web server 240 serves web pages, as well as other content, such as JAVA®, FLASH®, XML and so forth. The web server 240 may receive and route messages between the online system 140 and the client device 110, for example, instant messages, queued messages (e.g., email), text messages, short message service (SMS) messages, or messages sent using any other suitable messaging technique. A user may send a request to the web server 240 to upload information (e.g., images or videos) that are stored in the content store 210. Additionally, the web server 240 may provide application programming interface (API) functionality to send data directly to native client device operating systems, such as IOS®, ANDROID™, WEBOS® or BlackberryOS.

Determining Whether to Request One or More Advertisements from an Advertisement Service

FIG. 3 is an interaction diagram of one embodiment of a method for determining whether an online system 140 requests one or more advertisements from an advertisement service 130. In other embodiments, the method may include different and/or additional steps than those shown in FIG. 3. Additionally, steps of the method may be performed in different orders than the order described in conjunction with FIG. 3.

A client device 110 associated with a user transmits 305 to the online system 140 a request for content items to present in a feed of content items presented to the user. The request identifies the user; for example, a user identifier associated with the user by the online system 140 is included in the request. When the online system 140 receives the request, the online system 140 identifies 310 a set of additional content items eligible for insertion into the feed of content items that are not currently included in the feed. For example, the online system 140 identifies stories describing actions that were performed by additional users connected to the user (e.g., status updates, page posts, etc.) during a time interval between a current time and a time when the online system 140 received a previous request to refresh a newsfeed from the user. In some embodiments, the additional content items include one or more content items previously presented in the feed but not previously viewed by the user.

Additionally, the online system 140 retrieves 315 information describing content items and advertisements previously presented to the user in the feed (i.e., an existing state of the feed) and information describing content items in the set of additional content items. The retrieved information may include positions in the feed in which content items were previously presented, types of content included in the previously presented content items, types of content included in the additional content items, users associated with the previously presented content items, users associated with the additional content items, a number of additional content items, content items presented based on previously received requests for content, and any other suitable information. Further, the online system 140 identifies 320 one or more advertisement policies enforced by the online system 140 that each include one or more conditions preventing inclusion of one or more advertisements in the feed. Advertisement policies are further described above in in conjunction with FIG. 2 and may be stored by the online system 140, retrieved from a third party system 130, or obtained from any other suitable source.

Based on the information describing the previously presented content items, the additional content items, and the identified advertisement policies, the online system 140 determines 325 a predicted likelihood that enforcing the identified one or more advertising policies will prevent insertion of one or more additional advertisements into the feed of content items. As described above in conjunction with FIG. 2, advertising policies prevent insertion of an advertisement into a feed of content items by specifying positions in the feed in which advertisements are not eligible to be presented, by specifying by specifying a minimum distance separating advertisements in the feed, or by specifying any other suitable conditions preventing inclusion of an advertisement in the feed. The predicted likelihood may be expressed as a percentage or as a score and determined 325 by applying one or more machine learned models to characteristics of the user, characteristics of the feed, and conditions specified by the advertisement policies. Multiple models may be used to determine 325 the predicted likelihood that enforcing one or more advertisement policies will prevent inclusion of one or more advertisements in a feed, different models may be applied to different advertisement policies or various models may be applied to a particular advertisement policy. For example, the online system 140 determines 325 a 98% likelihood that enforcement of an advertising policy preventing advertisements from occupying a first position in a feed of content items will prevent insertion of an advertisement into a newsfeed if additional content items are not eligible for insertion into the newsfeed and a characteristic of the feed indicates that the first position in the feed is used to present a content item obtained by the online system 140 between a time when the user previously viewed the feed and a current time. In some embodiments, positions in a feed of content items are arranged in a chronological order, which may influence determination of the predicted likelihood that enforcement of advertisement policies will prevent inclusion of one or more advertisement in the feed.

In one embodiment, a trained model determines 325 the predicted likelihood that enforcing the advertising policies will prevent one or more advertisements from being inserted into the feed of content items. The model may be trained using information associated with the user and the feed. For example, a machine learned model determines 325 a predicted likelihood that enforcing one or more advertisement policies will prevent insertion of one or more advertisements into a feed based on a historical number of advertisements inserted into the feed in response to previously received requests for content from the user.

Based on the likelihood that enforcement of one or more advertisement policies prevents includes of one or more advertisements in the feed, the online system 140 determines 330 whether to request one or more additional advertisements from an advertisement service 135. The likelihood of the online system 140 determining 330 to request one or more additional advertisements from the advertisement service 135 is an inverse function of the likelihood that enforcement of one or more advertisement policies will prevent inclusion of one or more advertisement in the feed. Hence, a higher predicted likelihood that enforcement of advertising policies will prevent insertion of one or more advertisements into the feed of content items, the less likely the social networking system 140 determines 330 to request one or more additional advertisements from the advertisement service 135. In one embodiment, the online system 140 compares the predicted likelihood that enforcing one or more advertisement policies will prevent inclusion of one or more advertisement into the feed of content items is compared to a threshold value and determines 330 whether to request one or more advertisement from the advertisement service 135 based on the comparison. If the predicted likelihood that enforcing one or more advertisement policies will prevent inclusion of one or more advertisement into the feed of content items is at least the threshold value, the social networking system 140 determines 330 not to request additional advertisements from the advertisement service 135. However, if the predicted likelihood that enforcing one or more advertisement policies will prevent inclusion of one or more advertisement into the feed of content items is less than the threshold likelihood, the online system determines 330 to request one or more additional advertisements from the advertisement service 135. This allows the online system 140 to conserve computing resources by determining 330 not to request additional advertisements when additional advertisements received from an advertisement service 135 are unlikely to be inserted into the feed of content items.

If the online system determines 330 to request additional advertisements from the advertisement service, the online system 140 requests 335 one or more additional advertisements from the advertisement service 135. The request may identify the user to be presented with the feed, characteristics of the user, characteristics of advertisement to retrieve, or any other suitable information. Alternatively, the online system 140 requests 335 additional advertisements from the advertisement service 135 regardless of the predicted likelihood, includes an indication for the advertisement service 135 to ignore the request if the predicted likelihood that enforcement of the one or more advertisement policies will prevent inclusion of one or more advertisements in the feed. For example, the online system 140 includes an embedded code in the request to the advertisement service 135 if the predicted likelihood that enforcement of the one or more advertisement policies will prevent inclusion of one or more advertisements in the feed, when the advertisement service 135 identifies or executes the embedded code, the advertisement service disregards the request.

The advertisement service 135 identifies 340 one or more additional advertisements based on the request and transmits 345 the identified advertisements to the online system 140. Based on the additional advertisements and/or the additional content items, the online system 140 refreshes 350 the content feed. If the online system 140 requests 335 additional advertisements from the advertisement service 135 and receives identified advertisements from the advertisement service 135, the online system 140 refreshes 350 the feed to include content selected from the identified additional content items and the additional advertisements. In various embodiments, the additional content items and the additional advertisements are included in a selection process used by the online system 140 to select content included in the feed. If the online system 140 does not request 335 additional advertisements from the advertisement service 135, the online system 140 refreshes 350 the feed based on the identified additional content items.

In some embodiments, the online system 140 ranks the identified additional content items and any additional advertisements received from the advertisement service 135 and selects content items or advertisements for inclusion in the feed inserted based on the ranking. For example, additional content items eligible for insertion in a user's newsfeed are ranked by the online system 140 based on a predicted affinity of the user for the additional content items and additional advertisements are ranked at least in part on a bid amount associated with each additional advertisement. In some embodiments, the additional content items and the additional advertisements are ranked in a single ranking by applying a conversion factor to the affinities of the user for the additional content items or to the bid amounts of the additional advertisements to determine a common unit of measurement for the content items and the advertisements, which are then ranked together based on the a common unit of measurement. Ranking both advertisements and other types of content items in a single ranking is further described in U.S. patent application Ser. No. 13/545,266, filed on Jul. 10, 2012, which is hereby incorporated by reference in its entirety. Alternatively, the additional content items and the additional advertisements are separately ranked, with the feed refreshed 350 based on each ranking.

Alternatively, the online system 140 inserts additional content items or additional advertisements into positions of the feed of content items based on times when each additional content item or additional advertisement became eligible for insertion into the feed. For example, additional advertisements and additional content items available for insertion into the feed during a time interval between a current time and a time when the feed was previously refreshed are inserted into the feed in chronological order, with the most recent content inserted in higher positions of the feed. In some embodiments, content items and advertisements previously presented to the user retain their positions in the feed relative to each other, but are displaced downward by a number of positions occupied by the newly inserted content items. After refreshing 350 the feed of content items, the online system 140 communicates 355 the refreshed feed to the client device 110 for presentation to the user.

FIG. 4 is an example of determining whether to insert an additional advertisement into a feed of content items. In the example of FIG. 4, the feed 400 of content items includes content items 405A, 405B, 405C (also referred to individually and collectively using reference number 405) and advertisements 410A, 410B, 410C (also referred to individually and collectively using reference number 410). For purposes of illustration, FIG. 4 shows three content items 405A, 405B, 405C and three advertisements 410A, 410B, 410C included in the feed 400 of content items; however, any number of content items 405 and advertisements 410 may be included in a feed of content items 400. In the example of FIG. 4, content items 405A, 405B, 405C respectively occupy the first, third, and fourth positions of the feed 400 and advertisements 410B, 410C occupy, respectively, the second and fifth positions of the feed 400.

As shown in FIG. 4, the online system 140 determines whether to request an additional advertisement 410A from an advertisement service 135 for insertion into the feed 400 of content items based on a predicted likelihood that enforcing an advertisement policy specifying that advertisements in the feed 400 may not occupy two adjacent positions will prevent inclusion of the additional advertisement 410A into the feed 400 in a position between the content item 405B occupying the third position and the content item 405C occupying the fourth position in the feed 400. Here, the additional advertisement 410A may occupy the fourth position in the feed 400 without violating the advertising policy, as inclusion of the additional advertisement 410A in the feed displaces content item 405C and advertisement 410C, which are presented in positions of the feed 400 below the third position, downward. In this example, the online system 140 determines the predicted likelihood of enforcing the advertisement policy will prevent inclusion of the additional advertisement 410A in the feed 400 is less than a threshold value, so the online system 140 requests the additional advertisement 410A from the advertisement service 135.

As another example, in addition to the advertising policy specifying that advertisements in the feed 400 may not occupy two adjacent positions, the online system 140 may enforce additional advertising policies specifying that advertisements may not occupy a first position in the feed 400 and that additional content is inserted into the feed 400 in chronological order, with the newest content inserted in an uppermost position of the feed 400. If the online system 140 does not identify additional content items eligible for insertion into the feed 400 when determining whether to retrieve the additional advertisement 410A, the online system 140 determines the likelihood that enforcing the advertisement policies will prevent inclusion of the additional advertisement 410A in the feed is greater than the threshold value. Accordingly, the online system 140 determines not to request the additional advertisement 410A from the advertisement service 135.

In the example of FIG. 4, a machine learned model determines the predicted likelihood that enforcing advertising policies will prevent insertion of the additional advertisement 410A into the feed 400 based on a historical number of advertisements that have been inserted into the feed 400 in response to previous requests for presentation of additional content in the feed received from the user. In some embodiments, multiple models may be used to determine the predicted likelihood, with different models used for different advertisement policies. Alternatively, a model may determine the predicted likelihood based on multiple advertisement policies.

### SUMMARY

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
enforcing, at an online system, one or more advertising policies, each advertising policy describing one or more conditions preventing insertion of one or more advertisements into a feed of content items;
receiving a request to refresh a feed of content items for a user of the online system, the feed previously presented to the user and including one or more advertisements and a plurality of content items;
identifying a set of additional content items eligible for insertion into the feed;
retrieving information about one or more of the content items previously presented to the user in the feed and about the set of additional content items eligible for insertion into the feed;
determining a likelihood that the advertising policies will prevent insertion of one or more new advertisements into the feed based at least in part on the retrieved information;
determining whether to request one or more new advertisements from an advertisement service that provides advertisements for the feed based on the determined likelihood that one or more of the set of advertising policies will prevent insertion of the one or more new advertisements into the feed;
requesting one or more new advertisements from the advertisement service subject to the determining of whether to request one or more new advertisements from the advertisement service;
refreshing the feed by inserting one or more of: an additional content item of the additional content items and a new advertisement received from the advertisement service; and
providing the refreshed feed for display to the user.

2. The method of claim 1, wherein determining whether to request one or more advertisements from the advertisement service comprises:
comparing the determined likelihood to a threshold value; and
determining whether to request one or more advertisements from the advertisement service based at least in part on the comparison.

3. The method of claim 2, wherein determining whether to request one or more advertisements from an advertisement service based at least in part on the comparison comprises:
determining to request the one or more advertisements from the advertisement service if the determined likelihood is at least the threshold.

4. The method of claim 1, wherein the one or more conditions preventing insertion of one or more advertisements into the feed of content items include one or more positions in a feed in which an advertisements is not capable of being presented.

5. The method of claim 1, wherein the one or more conditions preventing insertion of one or more advertisements into the feed of content items include a minimum distance between positions in which advertisements are presented in the feed.

6. The method of claim 1, wherein the one or more conditions preventing insertion of one or more advertisements into the feed of content items include a minimum number of positions between positions in the feed in which advertisements are presented.

7. The method of claim 1, wherein the feed previously presented to the user comprises a newsfeed including content items selected for the user by the online system.

8. The method of claim 1, wherein the likelihood that the advertising policies will prevent insertion of any new advertisement into the feed based at least in part on the retrieved information is determined by a machine learned model.

9. The method of claim 8, wherein the machine learned model is based on one or more selected from a group consisting of: one or more previously received requests for content presented via the feed, one or more advertisements previously inserted into the feed in response to a previously received request for content presented via the feed, characteristics of the previously presented feed, content items included in the previously presented feed, characteristics of content item sin the set of additional content items, and any combination thereof.

10. The method of claim 8, wherein the machine learned model is trained based on one or more selected from a group consisting of: a time associated with the user, a location associated with the user, a client device associated with the user, a type of client device associated with the user, an amount of time elapsed between a time when a prior request to refresh the feed was received and a time when the request to refresh the feed was received, and any combination thereof.

11. The method of claim 1, wherein refreshing the feed by inserting one or more of: the additional content item of the additional content items and the new advertisement received from the advertisement service comprises:
ranking the additional content items and the one or more new advertisements received from the advertisement service; and
selecting the one or more of: the additional content item of the additional content items and the new advertisement received from the advertisement service based at least in part on the ranking.

12. The method of claim 1, wherein the additional content item of the additional content items and the new advertisement received from the advertisement service are inserted into one or more positions of the feed based at least in part on a time associated with each of the additional content item and the new advertisement.

13. A computer program product comprising a computer-readable storage medium having instructions encoded thereon that, when executed by a processor, cause the processor to:
enforce, at an online system, one or more advertising policies, each advertising policy describing one or more conditions preventing insertion of one or more advertisements into a feed of content items;
receive a request to refresh a feed of content items for a user of the online system, the feed previously presented to the user and including one or more advertisements and a plurality of content items;
identify a set of additional content items eligible for insertion into the feed;
retrieve information about one or more of the content items previously presented to the user in the feed and about the set of additional content items eligible for insertion into the feed;
determine a likelihood that the advertising policies will prevent insertion of one or more new advertisements into the feed based at least in part on the retrieved information;
determine whether to request one or more new advertisements from an advertisement service that provides advertisements for the feed based on the determined likelihood that one or more of the set of advertising policies will prevent insertion of the one or more new advertisements into the feed;
request one or more new advertisements from the advertisement service subject to the determining of whether to request one or more new advertisements from the advertisement service;
refresh the feed by inserting one or more of: an additional content item of the additional content items and a new advertisement received from the advertisement service; and
provide the refreshed feed for display to the user.

14. The computer program product of claim 13, wherein determine whether to request one or more advertisements from the advertisement service comprises:
compare the determined likelihood to a threshold value; and
determine whether to request one or more advertisements from the advertisement service based at least in part on the comparison.

15. The computer program product of claim 14, wherein determine whether to request one or more advertisements from the advertisement service based at least in part on the comparison comprises:
determine to request the one or more advertisements from the advertisement service if the determined likelihood is at least the threshold.

16. The computer program product of claim 13, wherein the one or more conditions preventing insertion of one or more advertisements into the feed of content items include one or more positions in a feed in which an advertisements is not capable of being presented.

17. The computer program product of claim 13, wherein the one or more conditions preventing insertion of one or more advertisements into the feed of content items include a minimum distance between positions in which advertisements are presented in the feed.

18. The computer program product of claim 13, wherein the one or more conditions preventing insertion of one or more advertisements into the feed of content items include a minimum number of positions between positions in the feed in which advertisements are presented.

19. A method comprising:
receiving a request to refresh a feed of content items for a user of an online system, the feed previously presented to the user and including one or more advertisements and a plurality of content items;
identifying a set of additional content items eligible for insertion into the feed;
retrieving information describing one or more of the content items previously presented to the user in the feed and information describing content items in the set of additional content items eligible for insertion into the feed;
determining a likelihood that one or more advertising policies enforced at the online system will prevent insertion of any new advertisement into the feed based at least in part on the retrieved information, each advertising policy describing one or more conditions preventing insertion of one or more advertisements into a feed of content items;
determining whether to request one or more advertisements from an advertisement service that provides advertisements for the feed based on the determined likelihood that one or more of the set of advertising policies will prevent insertion of a new advertisement into the feed; and
requesting one or more new advertisements from the advertisement service subject to the determining of whether to request one or more advertisements from an advertisement service.

20. The method of claim 19, further comprising:
refreshing the feed by inserting one or more of: an additional content item of the additional content items and a new advertisement received from the advertisement service; and
providing the refreshed feed for display to the user.
